(19) United States
(12) Patent Application Publication
(10) Pub. No.: US 2003/0045297 A1
(43) Pub. Date: Mar. 6, 2003

(54) Communication system employing channel estimation loop-back signals

(76) Inventor: Paul W. Dent, Pittsboro, NC (US)

Correspondence Address: COATS & BENNETT, PLLC, P O BOX 5, RALEIGH, NC, 27602, US

(21) Appl. No.: 09/939,006

(22) Filed: Aug. 24, 2001

(51) Int. Cl. H04Q 7/20

(52) U.S. Cl. 455/450; 455/455

(57) ABSTRACT

Transmit signal loop-back by a wireless receiver permits a transmitting network to estimate the characteristics of downlink propagation channels between one or more network transmitters and the receiver based on the loop-back signals. Downlink channel estimates may be, for example, used by the network in transmit pre-filtering. With transmit pre-filtering, transmit signals are compensated before transmission for the effects of the downlink propagation channels to, for example, reduce interference between multiple information signals being simultaneously transmitted to a number of wireless receivers. Loop-back techniques include but are not limited to the involved wireless receivers looping back at least a portion of the signal received from the transmitting network, which may then be processed by the network to estimate downlink channels. In some cases, the receivers may estimate downlink channels and provide these estimates to the network.

### BACKGROUND OF THE INVENTION

The present invention generally relates to wireless communication networks, and particularly relates to propagation channel estimation using loop-back signaling from mobile devices.

Wireless communication networks and the wireless devices associated with those networks employ a variety of techniques to improve performance and enhance communication quality and reliability. Some of these techniques are based on compensating a received signal for channel distortion caused by the propagation channel through which the signal was received. In these cases, the receiving system may use information embedded in the received signal that is known a priori to the receiver to determine the effects of the propagation channel on the received information. Unknown data in the received signal may then be compensated for the determined effects of the propagation channel, thereby enhancing receiver performance.

Such approaches are based on compensating radio signals post-reception for the effects of the radio channels through which the signals are propagated. Other techniques involve transmit or receive diversity, where more than one transmitting or receiving element is used to combat signal fading and other types of reception problems. In transmit diversity, more than one transmitter transmits signals to one or more receivers, with each receiver generally receiving a composite of the various transmitted signals. In receive diversity, more than one antenna element receives the transmitted signal. One basis for these diversity strategies is the assumption that at least one of the diversity propagation paths between the multiple transmitters and the receiver, or between the transmitter and the multiple receivers remains unfaded at all times.

### SUMMARY OF THE INVENTION

The present invention provides a method and apparatus for generating downlink propagation channel estimates in a wireless communication network characterizing the downlink propagation channels between one or more network transmitters and one or more wireless devices receiving signals from the network. Such downlink channel estimates may be used by the network to, for example, pre-filter the transmit signals such that interference from unwanted signals is reduced at each receiver. The wireless devices assist the network in generating the downlink channel estimates.

In general terms, the wireless devices may determine the downlink channel estimates themselves, and then transmit this channel state information (CSI) back to the wireless network, or the wireless devices may provide mobile-assisted downlink propagation channel estimation based on providing loop-back signals to the network. These loop-back signals contain at least a portion of the signal information received by the wireless devices from the network through the downlink propagation channels of interest, and may thus be used by the wireless network in generating estimates of the downlink propagation channel characteristics.

In other approaches, the wireless network transmits information to and receives information from the wireless devices on the same frequency. Under these conditions, the wireless network may derive uplink propagation channel information from the signals received by it from the wireless devices. Because the same transmission frequency is used on the downlink, the network may use this channel estimate information to compensate or otherwise pre-filter the signals it transmits to the wireless devices on the downlink propagation channels.

Where the network estimates downlink propagation channels based on loop-back signals it receives from the wireless devices, the wireless devices preferably add known uplink information to the loop-back signal. In this manner, the network can identify the influence of the uplink propagation channels on the loop-back signals. Because the channel effects within the loop-back signals are a product of the downlink and uplink propagation channels, the ability to divide out or otherwise remove the uplink channel effects allows the network to then determine the effects of the downlink propagation channels. From this, the network can effectively estimate the downlink propagation channel characteristics. With relatively rapid re-calculations of downlink channels, the network can maintain accurate downlink propagation channel estimates even for wireless devices with high mobility.

In approaches where loop-back signals are used, the wireless devices loop-back at least some of the signals received from the network 10. The network 10, having knowledge of the symbols transmitted by it to each of the wireless devices, can then perform various correlation operations with the loop-back signals to determine downlink propagation channel effects. In some cases, the network may add transmitter-specific information to the signals it transmits to aid in identifying the downlink propagation channels between the wireless devices and the network transmitters. Also, where the wireless devices are all communicating with the network on the same communications channel, such as frequency, the network may employ uplink beam forming/interference cancellation using uplink propagation channel estimates it derives from the loop-back signals.

### BRIEF DESCRIPTION OF THE DRAWINGS

FIG. 1 is a diagram of an exemplary communication network.

FIG. 2 is a diagram of an exemplary feedback apparatus in a mobile terminal used in the network of FIG. 1.

FIG. 3 is a diagram of exemplary details of apparatus supporting the loop-back channel.

FIG. 4 is a diagram of an exemplary physical arrangement of the loop-back channel.

### DETAILED DESCRIPTION OF THE INVENTION

Knowledge of the downlink propagation channels between one or more communication network transmitters and one or more corresponding wireless receivers may be useful in a variety of applications. The co-pending application entitled “COMMUNICATION SYSTEM EMPLOYING TRANSMIT MACRO-DIVERSITY” illustrates the use of downlink channel estimates in transmit signal pre-filtering, and is incorporated herein by reference in its entirety. In at least one approach outlined in this co-pending application, transmit pre-filtering uses downlink channel estimates to generate transmit signals that reduce unwanted signal interference at one or more wireless receivers. One or more of the various loop-back techniques that the instant application details may be applied to transmit pre-filtering processes outlined in the above co-pending application.

Moreover, the co-pending application entitled “COMMUNICATIONS SYSTEM EMPLOYING NON-POLLUTING PILOT CODES” relates to the above-incorporated co-pending application, and is also incorporated herein by reference in its entirety. This second co-pending application relates, at least in part, to the use of downlink channel estimation in an “over-dimensioned” transmit macro diversity scenario where a number of transmitters transmit to a smaller number of receivers. The involved communication network transmits additional information that influences the loop-back signal provided by the one or more receivers in a manner that facilitates downlink channel estimation.

While the two co-pending applications incorporated by reference above illustrate natural applications for the loop-back techniques disclosed herein, these exemplary applications are but specific examples. Transmit signal loop-back as practiced herein may be broadly applicable across a range of communication functions wherein knowledge of the downlink radio propagation channels between one or more transmitters and one or more wireless receivers is used to enhance communication reliability or performance in some fashion.

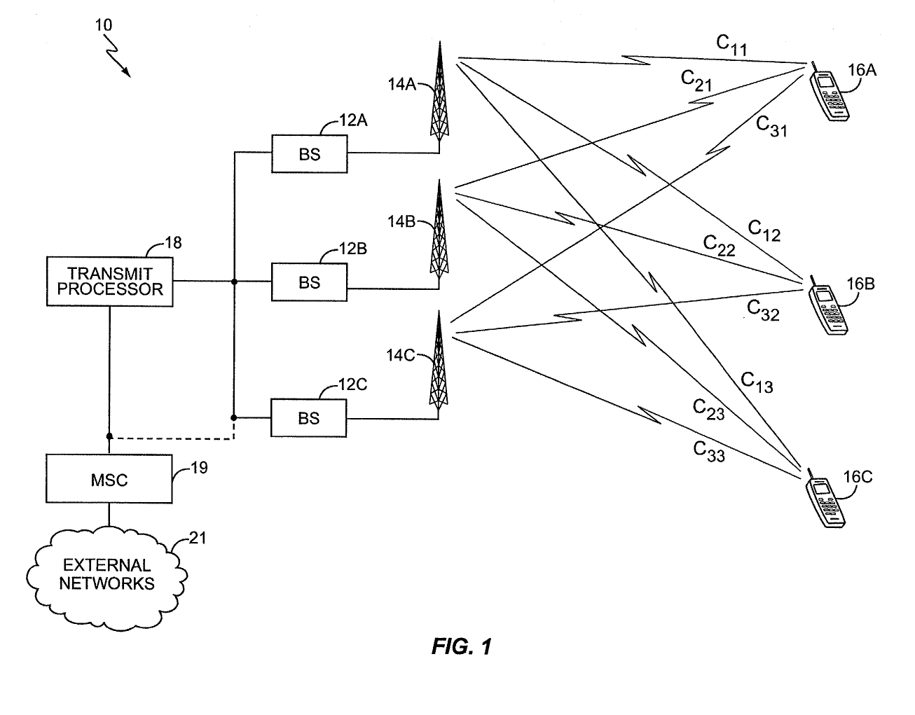

Turning now to the drawings, FIG. 1 illustrates an exemplary wireless communication network 10 in which the present invention may be practiced. Of course, it should be understood that the various techniques associated with the present invention are not limited to use within the illustrated network 10. The network 10 comprises a number of base stations 12, each with an associated antenna 14 for communicating via wireless signaling with one or more wireless devices 16, a transmit processor 18 for centralized pre-filtering of transmit signals to the wireless devices 16, and a mobile switching center (MSC) 19 to control network operation and communicatively interface the network 10 with one or more external networks 21, such as the Public Switched Telephone Network (PSTN) and the Internet.

Reference numbers 12 and 14 generally refer to base stations and their associated antennas within the network 10, respectively. Letter suffixes, such as “A,” “B,” and “C,” are used to denote a particular base station 12 or antenna 14. A similar scheme is used for referencing the wireless devices 16, which may be, for example, cellular radiotelephones or other types of mobile terminals. These wireless devices are generically referred to hereinafter as mobile terminals 10.

Generally, each base station 12 and antenna 14 function as both network transmitters and network receivers within the network 10, so that each base station 12 typically both sends and receives information to and from one or more of the mobile terminals 16. Radio frequency signals between the antennas 14 and the mobile terminals 16 follow radio propagation paths. Signals transmitted from an antenna 14 to a mobile terminal 16 follow a downlink propagation channel, while signals transmitted from the mobile terminal 16 to the antenna 14 follow an uplink propagation channel.

Downlink propagation channels between the antennas 14 and the mobile terminals 16 are illustrated in FIG. 1 as “C₁₁, C₂₁, C₃₁” and so on. This nomenclature is generalized as “Cⱼₖ,” where “j” represents the jth mobile terminal 16 and “k” represents the kth transmit antenna 14. Thus, C₁₁ represents the potentially multipath downlink propagation channel between mobile terminal 16A, considered the first mobile terminal, and antenna 14A, considered the first antenna. Further, C₃₂ denotes the downlink propagation channel between the third mobile terminal (mobile terminal 16C) and the second transmit antenna (antenna 14B). Similar nomenclature denotes each of the downlink propagation channels. In general, downlink channel information or channel estimate information may be broadly referred to as “channel state information,” denoted as CSI.

Each downlink propagation channel is potentially a multipath channel. Each multipath has a characteristic attenuation, phase, and delay attributes, which may be expressed as a complex coefficient representing magnitude and phase, and a corresponding delay attribute. Thus, a downlink propagation channel coefficient Cⱼₖ may be represented by the polynomial C₀+C₁z ¹+C₂z ²+. . . +Cₙ₋₁zⁿ⁻¹, where Cₙ represents the channel coefficient associated with a single multipath and z^{x} is a delay operator that represents the unit delay of the various multipaths relative to the first received multipath. The time delay operator could be expressed relative to a multipath other than the first received multipath, in which case the above expression might include channel coefficients with positive delay elements (e.g., Cₓz⁺⁴, Cₓ₋₁z⁺³, and so on).

In any case, the above expressions demonstrate that the multipath channel between any transmit antenna 14 and a mobile terminal 16 may be expressed as a polynomial in z, based on the channel coefficients and corresponding path delays associated with the multipaths involved. The complete set of channel coefficients from all antennas to all receivers forms a channel estimate matrix and may be expressed as follows:

$$[ \begin{matrix}{C}_{11} & {C}_{12} & {C}_{13} \\ {C}_{21} & {C}_{22} & {C}_{23} \\ {C}_{31} & {C}_{32} & {C}_{33}\end{matrix} ]$$

where each matrix element Cⱼₖ is a polynomial that corresponds to one multipath channel between a given transmit station or antenna and a given mobile terminal.

Channel coefficients are generally estimated by correlating a received signal with a corresponding transmitted signal to determine how propagation through the channel modified the transmitted signal. To facilitate channel estimation, the signals transmitted from the antennas 14 may contain known information or symbol patterns, generally referred to as synchronization words, training sequences, or pilot codes or symbols. Such information is known in advance to the mobile terminals 16, and is used by them to perform correlation operations with the received signal. The differences between the known sequences in the transmitted signal and the corresponding portions in the received signal may be identified by these correlation operations and used to generate channel estimates characterizing the propagation channel through which the received signal traveled.

While the above process may be used by the mobile terminals 16 to compensate the signals they receive from the network 10 for downlink channel distortion, the earlier incorporated co-pending applications detail techniques for using downlink channel estimates to advantageously pre-filter the transmit signals from the network 10.

More particularly, a coherent transmit macro-diversity scheme is detailed in the incorporated applications, wherein multiple transmit signals are pre-filtered using downlink channel estimates such that the transmit signals from the antennas 14 combine to reduce unwanted signal interference at each mobile terminal 16. This necessitates establishing and maintaining downlink channel estimates within the network 10. The pre-filtered transmit signals are generated as weighted combinations of the individual information signals intended for one or more mobile terminals 16. The downlink channel estimates are used to generate filter coefficients for the transmit filters applied to the individual information signals, and thus determine how the individual information signals are weighted in the different combinations used to form the transmit signals.

Several approaches are available for providing the network 10 with downlink channel estimates, or with information facilitating its determination of downlink channel characteristics. As noted above, the transmissions from the network 10 may include known information (e.g., pilot symbols) that facilitates channel estimation at the mobile terminals 16. Each mobile terminal 16 may then report these channel estimates to the network 10 at an appropriate update frequency. That is, a mobile terminal 16 would generate the channel estimate information by processing the signals it receives from one or more of the network antennas 14, and then transmit this information back to the network 10, where it may be organized for use in, for example, network transmit signal pre-filtering by the transmit processor 18.

Mobile-assisted channel estimation may be used as an alternative to mobile-based downlink channel estimation. In the mobile-assisted approach, the mobile terminals 16 may loop back some or a portion of the signals they receive from the network 10. This approach may be particularly appropriate where a mobile terminal user is principally desirous of receiving information from the network 10, such as in web browsing activities. Because all symbols and waveforms transmitted by the network 10 are known by the network, the network 10 is arguably in a better position to perform correlations on the loop-back signals that contain at least a portion of the previously transmitted symbols.

In the loop-back scenario, at least a portion of the loop-back signals received at the network 10 are equal to the signals transmitted by the network 10 propagated through the combination of the downlink channels to the mobile terminals 16 and the uplink channels from the mobile terminals 16. To divide out the effects of the uplink channels, the mobile terminals 16 preferably add known information to the loop-back signals that permit the network 10 to estimate the uplink channels. After removing uplink channel effects, the network 10 can then determine the downlink channel estimates. The earlier incorporated application entitled “COMMUNICATIONS SYSTEM EMPLOYING NON-POLLUTING PILOT CODES” details how the network 10 may transmit additional information symbols to dummy or imaginary receivers when the number of actual mobile terminals 16 is not sufficient to uniquely determine downlink channel estimates to each mobile terminal of interest.

In general, possible approaches to obtaining or generating downlink channel estimates include but are not limited to these items:

(i) Measuring downlink channel-related information in the receivers at the mobile terminals 16, and then transmitting these measurements back to the network 10 with a small turnaround delay. For example, the Universal Mobile Telecommunications System (UMTS) Wideband CDMA system (W-CDMA) has the ability to serve up to 200 voice users per frequency channel per cell, or a proportionally lower number of high bit-rate users such as mobile web-browsers. Therefore, for mobile web-browsers desirous of receiving a high instantaneous data rate, it is acceptable to use the whole capacity of a voice channel or more on the uplink to feed back CSI-related data.

(ii) Looping back to the transmitting network 10 at least some portion of the signals received at the mobile terminals 16, preferably with uplink-specific information known to the network 10 such that uplink channel effects may be divided out or otherwise canceled, thereby allowing estimation of the downlink channel characteristics. This approach may relieve the mobile terminals 16 of the need to encode and transmit downlink channel information back to the network 10.

(iii) Determining relative mobile terminal position in a mobile satellite communications system, where the relative coupling from transmit antenna elements to mobile terminals 16 is almost static.

(iv) Implementing a wireless-in-the-local-loop system for transmitting Internet or voice services wirelessly to the home, where the receive antenna is fixed.

(v) Implementing a mobile system wherein the mobile terminal 16 is likely to be stationary when high bitrate services are invoked.

(vi) Using the same channel frequency for both the downlink and uplink (from the mobile terminals 16 to the base stations 12) channels alternately in quick succession, thus implementing a so-called time-duplex or ping-pong system. Then the transmitting base stations 12 may assume that the downlink channels are the same as they measure on the uplink when decoding the signals received back from the mobile terminals 16.

The above approaches can all provide feedback of CSI, but the case of fast-moving mobile terminals 16 is the most challenging as the CSI changes rapidly, and low-delay, high-rate feedback of CSI is required. Scenarios requiring rapid feedback of changing CSI may favor the loop-back signal approach. Exemplary solutions for rapid feedback of changing CSI are described below.

In one “loop-back” approach, let C″ denote the current CSI or other downlink channel estimation information assumed by the transmitting system (e.g., network 10), which is in error from the correct CSI C by an error matrix E so that in matrix equation form:

[C′]=[C]+[E], or conversely [C]=[C′]−[E]. (Eq. 1)

The transmitter (antenna Tₖ) transmits [C′]⁻PⱼSⱼ, where Pⱼ is the effective net channel for signal Sⱼ. Pⱼ is the factor by which selected pre-filters in the transmit processor 18 used for transmit signal pre-filtering are in error. Here, the transmit pre-filters are based on the estimated channel information C′, and thus reflect any errors in those estimates as regards the actual or true downlink channel conditions C.

A given mobile terminal 16 as receiver R receives,

R(i)=[C]ᵢⱼ[C′]ₖⱼ⁻¹PⱼSⱼ, (Eq. 2)

where summation over the common index k is implied. The above expression reduces as follows:

=[C′−E]ᵢₖ[C′]ₖⱼ⁻¹PⱼSⱼ, (Eq. 3)

−PᵢSᵢ−[E]ᵢₖ[C′]ₖⱼ⁻¹PⱼSⱼ, (Eq. 4)

since [C′]ᵢₖ[C′]ₖⱼ⁻¹1 if i=j, else 0.

Thus a given mobile terminal 16 as receiverR correlates its received signal R(i) with known symbols embedded in the transmission Sⱼ to receiver(j) (e.g., another of the mobile terminals 16), the error polynomial term [E]ᵢₖ[C′]ₖⱼ ⁻¹ Pⱼ summed over index k will be obtained.

If all mobile terminals 16 perform these correlations for all j, including their own, and return the results to the network 10, the network 10 (e.g., within the transmit processor 18) can compute Eᵢⱼ and hence correct C′ᵢⱼ towards the actual or changing Cᵢⱼ, thereby tracking changes in the CSI. This is possible because the network 10 already knows or has access to the Sⱼ it transmitted, as well as to the pre-filter Pⱼ it used on its transmit signals, and the assumed CSI represented by C′ᵢⱼ.

From these interference correlations, the network 10 deduces how its CSI must have been in error, and corrects it. Specifically, receiver R₁ may report the polynomials determined by correlation with shifts of respective known symbol patterns as follows:

$$\begin{matrix}{X}_{11} ( z ) = {P}_{1} - {\sum }_{k} {E}_{1 k} {C}_{k1}^{- 1} {P}_{1} \\ {X}_{12} ( z ) = - {\sum }_{k} {E}_{1 k} {C}_{k2}^{- 1} {P}_{2} \\ ⋯ \\ {X}_{1 N} ( z ) = - {\sum }_{k} {E}_{1 k} {C}_{kN}^{- 1} {P}_{N}\end{matrix} \qquad ( Eq . 5 )$$

This is a set of N equations for the N unknown polynomials E₁₁, E₁₂, E₁₃ . . . E_{1N}. Likewise, receiver R₂ (e.g., another one of the mobile terminals 16) reports,

$$\begin{matrix}{X}_{21} ( z ) = - {\sum }_{k} {E}_{2 k} {C}_{k1}^{- 1} {P}_{1} \\ {X}_{22} ( z ) = {P}_{2} - {\sum }_{k} {E}_{2 k} {C}_{k2}^{- 1} {P}_{2} \\ ⋯ \\ {X}_{2 N} ( z ) = - {\sum }_{k} {E}_{2 k} {C}_{kN}^{- 1} {P}_{N}\end{matrix} \qquad ( Eq . 6 )$$

and this is a set of N equations for the N unknown polynomials E₂₁, E₂₂, E₂₃ . . . E_{2N}. Similarly, receiver R_{N} (e.g., the nth mobile terminal 16) reports

$$\begin{matrix}{X}_{N1} ( z ) = - {\sum }_{k} {E}_{Nk} {C}_{k1}^{- 1} {P}_{1} \\ {X}_{N2} ( z ) = - {\sum }_{k} {E}_{Nk} {C}_{k2}^{- 1} {P}_{2} \\ {X}_{NN} ( z ) = {P}_{N} - {\sum }_{k} {E}_{Nk} {C}_{kN}^{- 1} {P}_{N} ,\end{matrix} \qquad ( Eq . 7 )$$

which represents a set of equations for E_{N1}, E_{N2} . . . E_{NN}.

The solution of each of such sets of equations for one row of [E] is [C][P⁻¹]X, where [P⁻¹] is a diagonal matrix of the reciprocals of the pre-filters used in the transmit processor 18. If the reported measurements X were exact, the X polynomials would contain P as a factor, which would cancel. The remaining factors would give a solution for E that was entirely FIR, i.e. no denominator polynomials, as required. Refer to either of the earlier incorporated applications for exemplary details of the transmit processor's pre-filters.

Due to noise, the reported X polynomials probably will not have the exact matching property. A solution is to find the pure finite impulse response (FIR) solution of order L for E that best matches the frequency responses given by Equations 2-4 for E. For example, denominator roots from the pre-filter P can be paired with the closest numerator roots from C or X for annihilation until only numerator roots remain. These then yield the “best” pure FIR solution for E.

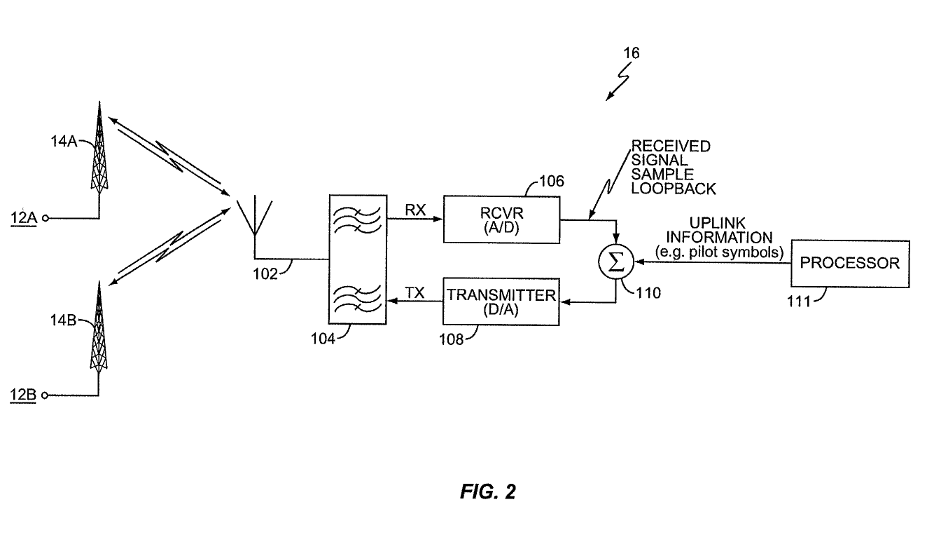

FIG. 2 illustrates another approach discussed above for providing channel state feedback from the mobile terminals 16 to the network 10. Here the transmit processor 18 additionally performs mobile terminal feedback correlation operations. For simplicity, only two base station/antenna sites are depicted (i.e., 12A/14A and 12B/14B). As before, the mobile terminal 16 receives transmit signals, denoted as T=hd 1 and T₂, from the transmit antennas 14A and 14B, respectively.

In an exemplary, simplified arrangement, the mobile terminal 16 comprises a transmit/receive antenna 102 coupled via a duplexer 104 to receive circuits 106 and transmit circuits 108. The receiver 106 filters, amplifies and converts the composite received signal to signal samples, preferably in digital form, i.e. using an A-to-D converter. At least some of the signal samples from the receiver 106 are then added in a summing circuit 110 with a pilot code and fed to transmitter circuits 104. A processor 111 may generate or provide the pilot code or symbols to the summing circuit 110. In exemplary arrangements, the processor 111 may comprise a system processor or microcontroller, or may comprise a portion of a baseband processing system, such as might be used by the mobile terminal 16 in receive and transmit signal processing.

The transmitter 108 converts the signal samples to a continuous signal using a D-to-A converter for digital samples, and the continuous signal is up-converted to a transmit frequency, amplified to an appropriate transmit power level, and transmitted via antenna 102 back to the network 10 (e.g., back to the transmitting base stations 12).

The base stations 12 receive these transmitted loop-back signals from various mobile terminals 16. The loop-back signals from different mobile terminals 16 may be separated by interference rejection combining of the signals from the different base station sites in the transmit processor 18. The transmit processor 18 may also include correlation functions that operate to correlate the loop-back signals from the mobile terminals 16 with the pilot codes or other known uplink information inserted by the mobile terminals 16 to determine the involved uplink propagation channels.

Within the network 10, correlations are also computed between the loop-back signals received from the mobile terminals 16 and the corresponding signals transmitted by the network 10 from each of its transmit sites (e.g., base stations 12) to determine the total loop-back channel, which is a product of the downlink and uplink propagation channels, for each base station transmit site. The uplink channel effects are then divided out to reveal the effects of the downlink propagation channels. If necessary, the network sites (e.g., base stations 12) can also each add a different, low-level pilot code to their transmissions, which would be chosen to assist in this loop-back channel determination, if for any reason the information-bearing waveforms were unsuitable. Using this method, the mobile terminals 16 are relieved of the complexity of performing downlink channel determination.

Generally, it is desirable to simplify mobile terminals 16 due to their high production volumes, and place complexity instead in the networks 10, which are much less numerous. Thus a simplified method by which the mobile terminals 16 can feedback downlink channel information to the transmitting network 10 would be useful. For example, the signal received at each mobile terminal 16 could be simply turned around and retransmitted with minimum delay back to the network, as shown already in FIG. 2.

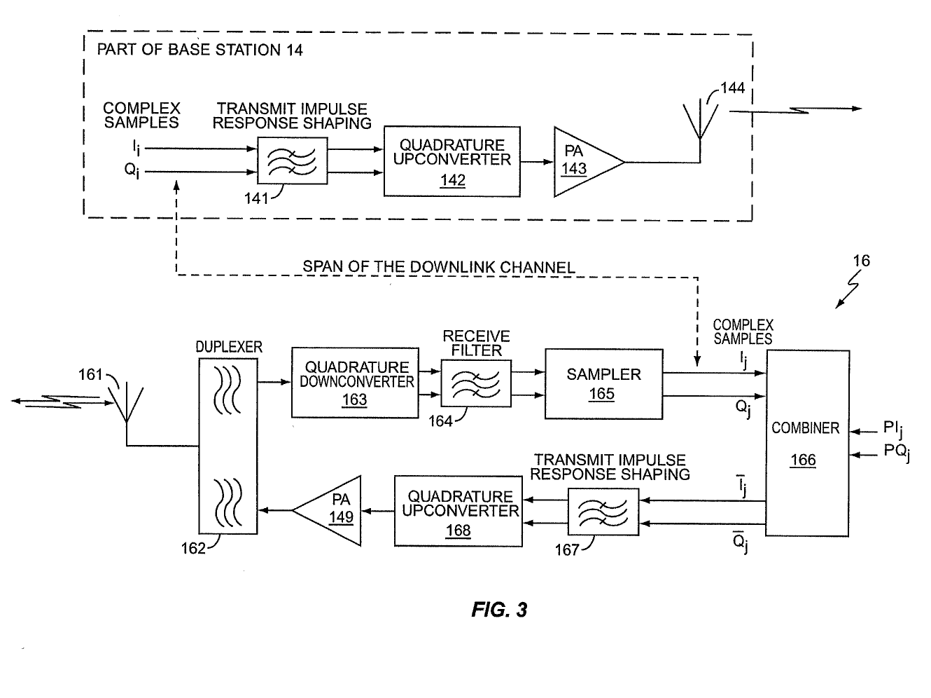

FIG. 3 shows more exemplary detail of the elements encompassed within the definitions of the uplink and downlink channels determined according to one or more embodiments of this invention.

Base stations 14 each comprise a transmitter or transmitter portion comprising transmit impulse-response shaping filters 141, upconverter 142, and radio frequency power amplifier (PA) 143. Information to be transmitted is originally defined at discrete time instants in the form of complex samples (Iᵢ, Qᵢ). These complex samples are then converted to continuous waveforms by the transmit impulse-response shaping filters 141. The continuous waveforms modulate a radio frequency carrier wave and are upconverted by upconverter 142 to the assigned downlink frequency channel. The PA 143 amplifies the signal to the desired transmit power level for transmission by antenna 144.

The mobile terminals 16 receive the signal transmitted by the base station 14 using mobile antenna 161 and pass the received signal to receive circuits via transmit/receive duplexer 162. The mobile receiver or receive circuits in the mobile terminals 16 comprise a quadrature downconverter 163, IF and/or baseband receive filters 164, and sampler 165.

Receive bandwidth limitations may be imposed either before or after downconverting the received signal from duplexer 162 via downcoverter 163, using Intermediate Frequency (IF) bandpass filters, or alternatively or additionally using baseband receive filtering 164 after conversion to the complex baseband. The receiving circuits also sample the received and downconverted signal using sampler 165 to produce complex baseband samples (Iⱼ, Qⱼ) at discrete time instants, which are usually converted from analog to digital format (A to D) to form numerical values for subsequent numerical signal processing. The downlink channel generally comprises everything between the input of complex samples (Iⱼ, Qⱼ) at the base station transmitter to the output of complex samples (Iⱼ, Qⱼ) from the mobile receiver.

It is customary to choose the transmit and receive filters each to be root-Nyquist so that their product is a Nyquist filter, which, in the absence of multipath propagation, would result in samples at the mobile station receiver output being substantially equal to samples at the base station transmitter input when sampled at the correct instants. The mobile terminal 16 according to this invention may, using combiner 166, add or otherwise combine an uplink pilot sample stream (PIⱼ, PQⱼ) with the mobile receiver output samples (Iⱼ, Qⱼ) to obtain combined samples (Iⱼ, \overline{Q}ⱼ) for transmission by the transmitter portion of the mobile station comprising transmit pulse shaping via pulse shaper 167, quadrature upconversion using quadrature upconverter 168 and transmit power amplification via PA 169.

Duplexer 162 couples the amplified transmit signal from PA 169 to the same antenna 161 used by the receiver portion of the mobile terminal 16 to allow transmit and receive from the same antenna. Simultaneous transmit and receive requires the use of duplexer filters, but alternating transmit and receive can employ a transmit/receive switch in place of duplexing filters.

The base station 14 comprises receiver circuits or components similar to the receiver portion of the mobile terminal 16 (e.g., 162,163, 164,165), so are not shown. The uplink channel determined according to this invention may comprise everything from the input of complex samples from combiner 166 to transmit filter 167 to the output of complex samples at the base station equivalent of sampler 165. Thus the uplink comprises mobile transmit pulse shaping 167, the uplink propagation channel between the mobile terminal 16 and the base station 14, and the base station equivalent of receive filtering 164.

Providing combiner 166 couples pilot samples PIⱼ, PQⱼ to the mobile transmitter in the same way as it couples the loop-back samples (Iᵢ, Qᵢ) to the mobile transmitter, the uplink channel for the pilot samples will be identical to the uplink channel for the loop-back samples, and thus determining the uplink channel at the base station 14 by correlation or least-squares estimation using the pilot samples also determines the uplink channel part of the loop channel. The loop channel is the product of the downlink and the uplink channels and comprises everything from the complex sample input to the base station transmitter to the complex sample output of the base station receiver (not shown), and may be determined by correlating the base station receiver output samples with the base station transmitted samples. The downlink channel may then be determined by dividing out the uplink channel from the loop channel.

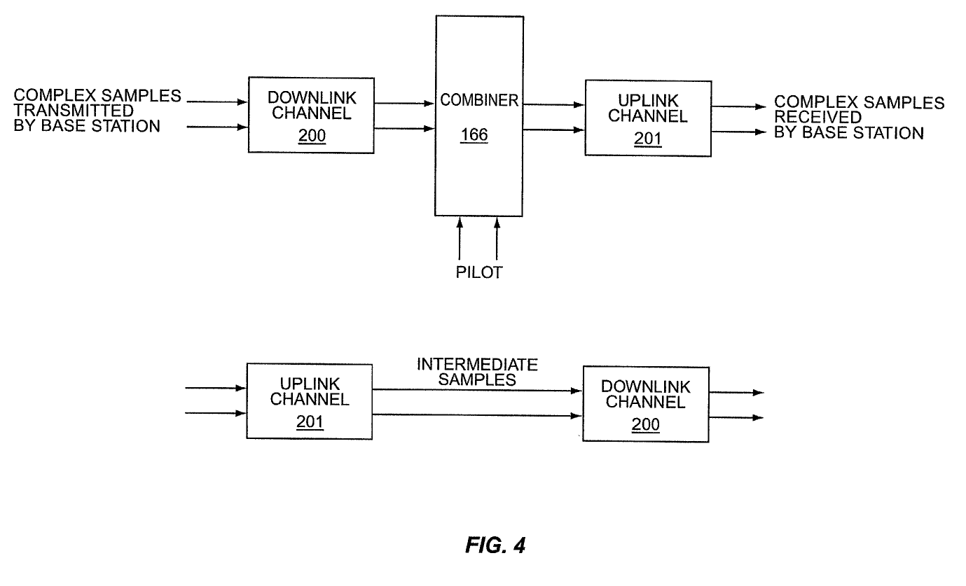

An alternative method of estimating the downlink channel is explained with the aid of FIG. 4. The upper half of the diagram shows an actual physical arrangement of the loop channel comprising the complex samples transmitted from the base station 14 passing first through the downlink channel 200 and then through the uplink channel 201 as they are transmitted back to the base station 14 from the mobile terminal 16 on the return path of the loop. The addition of the pilot stream samples at combiner 166 in the mobile terminal 16 allows determination of the uplink channel 201 by the network 10. Due to supposed linearity of the uplink and downlink channels, their order can be interchanged as shown in the lower half of the diagram without affecting the loop channel.

Since this interchanged ordering arrangement does not correspond to reality however, the intermediate samples that are equal to the transmitted samples passed only through the uplink do not occur. However, they may be calculated by passing the transmit samples through the uplink channel 201, which is determined by using the pilot samples. Having calculated the intermediate samples, it may be noted that the loop-back samples received at the base station 14 are, according to the lower half of FIG. 4, equal to the intermediate samples passed only through the downlink channel. Therefore the downlink channel may be determined by correlating the loop-back received samples with the calculated intermediate samples, i.e. by using least-squares channel estimation with the calculated intermediate samples treated as a known pilot stream.

If all mobile stations 16 loop-back on the same communication (logical) channel, the network 10 preferably separates the different mobile terminal loop-back signals by uplink beam forming/interference cancellation, which implies knowledge of uplink CSI. As discussed above, uplink CSI is also needed to divide out the effects of the uplink channels' propagation characteristics on the loop-back signals so that they reflect only the effects of the various downlink channels to the mobile stations 16.

In a CDMA system, the mobile stations 16 can retransmit back to the network 10 the signals they receive from the network 10 through the downlink propagation channels with the addition of uncorrelated pilot code sequences. These uncorrelated sequences added to the loop-back signals from the mobile terminals 16 permit the network 10 to derive the uplink CSI (e.g., the uplink propagation channel characteristics).

In a non-CDMA system that would not tolerate overlapping pilot sequences, the loop-back signals from the mobile stations 16 to the network 10 may instead be periodically interrupted at known times to insert pilot symbols that the network 10 can use to derive uplink CSI. Thus a modification to FIG. 2 may comprise interrupting the loop-back signal to insert pilot symbols or other known information by replacing the additive combination of pilot and loop-back signals formed in the summing circuit 110. In general, any suitable combination of the loop-back signals with mobile-specific pilot symbols or mobile-discriminating information can be used, and is represented by the combiner 166 in FIGS. 3 and 4. Thereby the onus for analyzing what the mobile stations 16 have received is placed back on the network 10.

The network 10 has the great advantage of knowing every symbol that was transmitted to every mobile station 16 and what transmit pre-filters were used in the generation of all the transmit signals transmitted by the network 10 to the mobile terminals 16. The network 10 can therefore perform correlations using the entire symbol sequence, waveform, or a portion thereof, transmitted to each mobile terminal 16, including data symbols and not just known pilot symbols.

Many variations of the above principle of “mirror reflection” of the received signals back to the network 10 can be devised. For example in a CDMA system, the received signal at each mobile terminal 16 can be despread using the codes of each mobile terminal 16 to obtain despread soft symbols. Then, the despread soft symbols can be respread using corresponding uplink codes and added. The multi-code uplink signal may then be mirrored from each mobile terminal 16 to the network 10.

Interference correlations (the X polynomials in the equations above—see Equations 5-7 for example) can also be digitally coded of course, and transmitted as a data stream protected by error correction coding. For high symbol rates giving long channel polynomials (large numbers of delay components) or for large numbers of network transmitters (e.g., greater than three antennas 14) the amount of digital information to be transmitted may exceed the uplink capacity available from each mobile terminal 16. Uplink capacity may be presumed to be for example the capacity of one voice channel, or about 4 to 12 kilobits per second.

The information to be sent to the network 10 could be selectively reduced by including in the reports only the X polynomial or polynomials having the greatest coefficient magnitudes, including only polynomial coefficients that had changed by more than a threshold amount from a predicted value, or by some other means of down-selecting. Reporting only the coefficient with the greatest magnitude will cause the network 10 to correct its transmitted signals to reduce only that largest interference component. However, if this action is repeated sequentially, it will reduce multiple interference components in order of strongest components first.

The present invention may, of course, be carried out in other specific ways than those herein set forth without departing from the spirit and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method of providing a wireless communication network with downlink propagation channel information, the method comprising:
receiving a first signal at a wireless device transmitted from a network transmitter through a downlink propagation channel;
determining a channel estimate for the downlink propagation channel at said wireless device based on receiving said first signal;
transmitting said channel estimate from said wireless device to a network receiver within the wireless communication network.

2. The method of claim 1 wherein receiving a first signal at a wireless device transmitted from a network transmitter through a downlink propagation channel comprises receiving at least one transmit signal containing information known to the wireless device.

3. The method of claim 2 wherein determining a channel estimate for the downlink propagation channel at the wireless device based on receiving the first signal comprises:
correlating the information known to the wireless device with the first signal; and
estimating channel characteristics of the downlink propagation channel based on the results of said correlation.

4. The method of claim 3 wherein transmitting the channel estimate from the wireless device to a network receiver within the wireless communication network comprises transmitting said channel characteristics back to said wireless communication network.

5. A method of generating a channel estimate for a downlink propagation channel in a wireless communication network, the method comprising:
transmitting a first signal from said network to a wireless device through the downlink propagation channel;
receiving a second signal at said network from the wireless device comprising channel estimate information derived from the first signal for the downlink propagation channel; and
setting a channel estimate in said network for the downlink propagation channel based on the channel estimate information.

6. The method of claim 5 further comprising updating said channel estimate in said network based on subsequent channel estimate information received from the wireless device.

7. The method of claim 5 further comprising:
receiving channel estimate information from a plurality of wireless devices; and
setting a plurality of channel estimates in said network for downlink propagation channels corresponding to the plurality of wireless devices based on said channel estimate information.

8. A method of generating a channel estimate for a downlink propagation channel in a wireless communication network, the method comprising:
receiving a first signal at a wireless device transmitted from a network transmitter through one or more downlink propagation channels;
generating a loop-back signal at the wireless device comprising at least a portion of the first signal; and
transmitting the loop-back signal from the wireless device to a network receiver associated with the wireless communication network, wherein the first signal is known by the network, such that the loop-back signal may be used by the network to estimate the downlink propagation channel.

9. The method of claim 8 wherein generating a loop-back signal at the wireless device comprising at least a portion of the first signal comprises adding at least a portion of the first signal together with uplink information known to the network.

10. The method of claim 9 wherein adding at least a portion of the first signal together with uplink information known to the network comprises adding uplink pilot information to the loop-back signal, such that the network can estimate uplink propagation channel characteristics using said uplink pilot information.

11. The method of claim 8 wherein generating a loop-back signal at the wireless device comprising at least a portion of the first signal comprises:
looping back at least a portion of the first signal; and
interrupting loop-back of the first signal periodically to transmit uplink information known to the network.

12. The method of claim 8 generating a loop-back signal at the wireless device comprising at least a portion of the first signal comprises adding mobile-specific information to the portion of the first signal looped back to form said loop-back signal.

13. A method of generating a channel estimate for a downlink propagation channel in a wireless communication network, the method comprising:
transmitting a first signal to a wireless device through the downlink propagation channel;
receiving a loop-back signal from the wireless device at a network receiver associated with the wireless communication network, said loop-back signal comprising at least a portion of the first signal; and
generating a channel estimate for the downlink propagation channel based on said loop-back signal from the wireless device.

14. The method of claim 13 wherein generating a channel estimate for the downlink propagation channel based on the loop-back signal from the wireless device comprises correlating said loop-back signal with signal information used to generate said first signal.

15. The method of claim 13 further comprising removing uplink propagation channel effects from said loop-back signal.

16. The method of claim 15 further comprising generating said channel estimate for the downlink propagation channel after removing said uplink propagation channel effects from said loop-back signal.

17. The method of claim 15 wherein removing uplink propagation channel effects from said loop-back signal comprises:
correlating said loop-back signal with known uplink information;
determining said uplink propagation channel effects based on said correlation; and
canceling said uplink propagation channel effects from said loop-back signal.

18. The method of claim 13 further comprising:
transmitting a plurality of first signals to a plurality of wireless devices;
receiving a plurality of loop-back signals from the plurality of wireless devices; and
generating a plurality of channel estimates for downlink propagation channels associated with the plurality of wireless devices based on said plurality of loop-back signals.

19. The method of claim 18 further comprising removing uplink propagation channel effects from each one of said plurality of loop-back signals.

20. The method of claim 19 further comprising generating said plurality of channel estimates after removing said uplink propagation channel effects from said plurality of loop-back signals.

21. The method of claim 19 wherein each one of said loop-back signals includes mobile-specific uplink information known to said network, and wherein removing uplink propagation channel effects from each one of said plurality of loop-back signals comprises correlating each one of said plurality of loop-back signals with the corresponding mobile-specific uplink information.

22. A method of providing a wireless communication network with downlink propagation channel information, the method comprising:
receiving first signals transmitted by the network as a composite received signal, said first signals combining at said wireless device to provide wanted information to the wireless device while canceling unwanted information intended for other wireless devices;
determining an amount of interference at said wireless device associated with the unwanted information arising from imperfect cancellation of the unwanted information; and
transmitting interference information back to the wireless communication network, wherein said interference information indicates network-based downlink channel estimation error to the network.

23. The method of claim 22 wherein determining an amount of interference at said wireless device associated with the unwanted information arising from imperfect cancellation of the unwanted information comprises correlating said composite received signal with known information embedded in said composite received signal.

24. The method of claim 23 wherein said known information comprises mobile-specific known information for each one of a plurality of wireless devices, including said wireless device and said other wireless devices, and wherein correlating said composite received signal with known information embedded in said composite received signal comprises correlating said composite received signal with said mobile-specific known information to determine an amount of interference caused by said unwanted information signals for said other wireless devices.

25. The method of claim 22 wherein transmitting interference information back to the wireless communication network comprises transmitting an interference measurement of un-cancelled interference caused by the unwanted signals back to the network.

26. The method of claim 25 wherein transmitting an interference measurement of un-cancelled interference caused by the unwanted signals back to the network comprises transmitting interference measurements for each one of a plurality of unwanted signals corresponding to a plurality of other said wireless devices.

27. The method of claim 22 further comprising:
receiving a plurality of composite received signals at a plurality of wireless devices, wherein said composite received signal at each said wireless device comprises a wanted information signal for said wireless device and interfering unwanted information signals corresponding to other ones of said plurality of wireless devices;
determining an amount of interference from said interfering unwanted information signals at each one of said plurality of wireless devices; and
transmitting interference information bearing on said amount of interference from each one of said plurality of wireless devices back to the network.

28. A method of generating channel estimates for downlink propagation channels in a wireless communication network, the method comprising:
transmitting first signals from network transmitters to a plurality of wireless devices, such that said first signals combine at each said wireless device to cancel unwanted information signals for other ones of said plurality of wireless devices;
receiving unwanted signal interference measurements from said plurality of wireless devices; and
updating said channel estimates of downlink propagation channels used by said network in generating said first signals based on said unwanted signal interference measurements, such that unwanted signal interference is reduced at said plurality of wireless devices.

29. The method of claim 28 wherein updating said channel estimates of downlink propagation channels used by said network in generating said first signals based on said unwanted signal interference measurements comprises:
determining an amount by which each of said channel estimates is in error based on said unwanted signal interference measurements; and
adjusting said channel estimates based on said errors so as to reduce said unwanted signal interference at said wireless devices.

30. The method of claim 28 wherein transmitting first signals from network transmitters to a plurality of wireless devices comprises:
generating an information signal for each one of said wireless devices;
combining said information signals using said channel estimates to generate said first signals as weighted combinations of said information signals; and
transmitting said first signals from a plurality of network transmitters, such that each said wireless device receives a composite received signal as a combination of said first signals.

31. The method of claim 30 wherein the extent to which said unwanted signals cancel at each one of said wireless devices depends on how well said channel estimates match actual downlink propagation channel estimates between said network transmitters and said wireless devices, and wherein updating said channel estimates of downlink propagation channels used by said network in generating said first signals based on said unwanted signal interference measurements comprises adjusting said channel estimates such that said unwanted signal interference is reduced at said wireless devices.

32. A mobile terminal comprising:
a receiver to generate a received information signal based on receiving a radio signal from a remote transmitter in a wireless network;
a transmitter to generate a transmit signal for transmission to a remote receiver in said wireless network based on processing a transmit information signal;
a combiner to form said transmit information signal based at least in part on said received information signal, such that said transmit signal from said mobile terminal functions as a loop-back signal for said wireless network.

33. The mobile terminal of claim 32 further comprising a processor to generate a pilot information signal, and wherein said combiner generates said transmit information signal at least in part based on combining said received information signal with said pilot information signal, such that said loop-back signal to said wireless network carries pilot information from said mobile terminal.

34. The mobile terminal of claim 33 wherein said combiner generally operates to form said transmit information signal based on said received information signal, but periodically operates to form said transmit information signal based on said pilot information signal, such that said loop-back signal to said wireless network comprises looped-back transmit information from said wireless network, interspersed with pilot information from said mobile terminal.

35. The mobile terminal of claim 33 wherein said processor generates said pilot information, such that said pilot information signal distinguishes said mobile terminal with said wireless network, thereby allowing said wireless network to determine said mobile terminal as the source of said loop-back signal.
